(19) United States
(12) Patent Application Publication
(10) Pub. No.: US 2017/0178680 A1
(43) Pub. Date: Jun. 22, 2017

(54) WANDERING WRITE PROTECTION FOR SHINGLED MAGNETIC RECORDING STORAGE DEVICES

(71) Applicant: NetApp, Inc., Sunnyvale, CA (US)

(72) Inventors: John William Haskins, JR., Wake Forest, NC (US); David Anthony Slik, Northridge, CA (US); Keith Arnold Smith, Cambridge, MA (US); Maxim Gerald Smith, Durham, NC (US)

(21) Appl. No.: 14/978,729

(22) Filed: Dec. 22, 2015

(51) Int. Cl. G11B 20/10; G11B 20/12; G11B 20/18; G06F 3/06

(52) U.S. Cl. CPC G11B 20/10009; G06F 3/0619; G06F 3/065; G06F 3/0676; G11B 20/1217; G11B 20/1816

(57) ABSTRACT

A method includes receiving a write request to write a current data block to a Shingled Magnetic Recording (SMR) storage device. In response, the current data block is written to a current physical block in an open zone of the SMR storage device. A corresponding copy of the current data block is written to a nonvolatile memory. A determination is made of whether a wandering write error occurred during the writing of the data to the open zone. In response to the wandering write error occurring, for each of the number of written physical blocks in the open zone that have the corresponding copy in the nonvolatile memory, the data in the physical block is validated using the corresponding copy. In response to validation, the data in the corresponding copy is written as corrected data for the physical block to a new zone in the SMR storage device.

### BACKGROUND

The disclosure generally relates to the field of data storage, and more particularly to protection against wandering writes for Shingled Magnetic Recording (SMR) storage devices.

An increasing amount of data is being stored. Although the per unit cost associated with storing data has declined over time, the total costs for storage have increased for many corporate entities because of the increase in volume of stored data.

In response, manufacturers of data storage drives (e.g., magnetic hard disk drive) have increased data storage capacity by using various techniques, including increasing the number of platters and the density of tracks and sectors on one or both surfaces of the platters. A platter is commonly a circular disk having one or both sides of a rigid substrate coated with a magnetic medium, on which data is stored. Data storage devices typically have several platters that are mounted on a common spindle. Each side on which data is stored commonly has an associated read head and a write head, or sometimes a combined read/write head. The platters are rotated rapidly within the data storage device about the spindle, and an actuator moves heads toward or away from the spindle so that data can be written to or read from tracks. A track is a circular path on the magnetic surface of the platters. One way of increasing data storage capacity is to have very narrow tracks and to place heads very close to the surface of the platter, e.g., micrometers (also, “microns”) away. However, because it takes more energy to write data than to read data (e.g., because the magnetic surface of platters must be magnetized to store data), data storage drive manufacturers inserted a buffer track between tracks storing data so that a wider track can be written to than read from. The buffer tracks could be magnetized when tracks on either side of the buffer tracks (“data tracks”) were written to, but read heads would only read from data tracks and ignore buffer tracks. However, buffer tracks decrease available space on platters.

To avoid wasting space on buffer tracks, a technique employed by the industry is shingled magnetic recording (“SMR”). SMR is a technique to increase capacity used in hard disk drive magnetic storage. Although conventional data storage devices as described above record data by writing non-overlapping magnetic tracks parallel to each other, SMR involves writing new tracks that overlap part of the previously written magnetic track, leaving the previously written magnetic track thinner, thereby allowing for higher track density. The SMR tracks partially overlap in a manner similar to roof shingles on a house.

For SMR drives, a disk can include a number of concentric, overlapping tracks on which data is stored on the surface. A number of zones can be defined on a disk, wherein each zone can include a group of tracks. Generally, data is written to sequential physical blocks within a zone (e.g., physical blocks that have monotonically increasing Physical Block Addresses (PBAs)). Once data has been written to a particular physical block within a zone, that physical block is not modified unless the previous physical blocks within the zone are rewritten as well. Thus, to modify the data stored at a particular physical block, data from the entire zone is read from the disk, the data for the appropriate physical block is modified, and the entire zone is written back to the disk (referred to as a “read-modify-write operation”).

### SUMMARY

In some embodiments, a method includes receiving a write request to write a current data block to a Shingled Magnetic Recording (SMR) storage device. In response to receiving the write request, the current data block is written to a current physical block in an open zone of the SMR storage device, wherein the open zone includes a number of written physical blocks that include stored data. Also, a corresponding copy of the current data block is written to a nonvolatile memory that includes corresponding copies of previous data blocks that were written to the SMR storage device. A determination is made of whether a wandering write error occurred during the writing of the data to the open zone. In response to wandering write error occurring, for each of the number of written physical blocks in the open zone that have the corresponding copy in the nonvolatile memory, the data in the physical block is validated based on the data in the corresponding copy. In response to a failure of the validation check of the data in the physical block, the data in the corresponding copy is written as corrected data for the physical block to a new zone in the SMR storage device.

This summary is a brief summary for the disclosure, and not a comprehensive summary. The purpose of this brief summary is to provide a compact explanation as a preview to the disclosure. This brief summary does not capture the entire disclosure or all embodiments, and should not be used limit claim scope.

### BRIEF DESCRIPTION OF THE DRAWINGS

Embodiments of the disclosure may be better understood by referencing the accompanying drawings.

FIG. 1 depicts a system using a dual-use First In First Out (FIFO) (hereinafter, FIFO) to provide for wandering write protection and logical block buffering in an SMR storage device, according to some embodiments.

FIG. 2 depicts a more detailed diagram of a part of an SMR storage device and a nonvolatile memory used to correct corrupted data caused by a wandering write error, according to some embodiments.

FIGS. 3-4 depict flowcharts to provide for wandering write protection and logical block buffering in an SMR storage device using a dual-use FIFO, according to some embodiments.

FIG. 5 depicts a system using a FIFO to provide for wandering write protection in an SMR storage device, according to some embodiments.

FIGS. 6-7 depict flowcharts to provide for wandering write protection in an SMR storage device, according to some embodiments.

FIG. 8 depicts an example computer device, according to some embodiments.

### DESCRIPTION

The description that follows includes example systems, methods, techniques, and program flows that embody the disclosure. However, it is understood that this disclosure may be practiced without these specific details. For instance, this disclosure refers to use of First In First Out (FIFOs) in illustrative examples. But aspects of this disclosure can use other types of data structures (e.g., arrays, tables, etc.) to provide for wandering write error protection. In other instances, well-known instruction instances, protocols, structures and techniques have not been shown in detail in order not to obfuscate the description.

### Overview

In contrast to conventional hard drives, an SMR storage device (e.g., SMR drive) is more likely to write to unintended locations during a write operation. For example, the write operations may unintentionally write to a different track, a different physical sector on a same track, etc. These unintended writes are known as wandering write errors. Wandering write errors can occur more frequently in SMR storage devices because of the proximity of new tracks to previously written tracks on the drives. Wandering write errors can write to unintended physical blocks or sectors that may or may not include previously written data.

In some embodiments, corrective operations to recover previously written data (further described below) are performed in response to wandering write errors that overwrite previously written data. In some embodiments, these corrective operations are not performed in response to wandering write errors that do not overwrite previously written data (e.g. unwritten physical blocks).

In preparation of performing corrective operations, data written to an SMR storage device can also be written to a nonvolatile memory. For example, a duplicate copy of the data written to an SMR storage device can be written to a data structure (e.g., a First In First Out (FIFO)) in the nonvolatile memory. The FIFO can maintain copies of a defined number of previously written data blocks depending on the FIFO size. Accordingly, if a wandering write error were to occur during a write of a current data block, the previously written data blocks stored in the FIFO can be used to recover from such an error.

Additionally, an SMR storage device can include a number of zones for writing data. The zones can be in different states (e.g., open, closed, etc.). In some embodiments, there can be a FIFO assigned to each zone that is open for writing data thereto. Inherently, SMR storage devices are configured such that update-in-place operations are not allowed. Therefore, the open zone where the wandering write error occurred cannot be corrected in place. Rather, some embodiments can use the uncorrupted data in the open zone in the SMR storage device along with the uncorrupted copy in the FIFO of any corrupted data in the SMR storage device to recreate the data (without corruption) in a new zone of the SMR storage device.

In some embodiments, the same FIFO can have a second use. For SMR storage devices, data (e.g., in a logical block) is written on physical block boundaries. In other words, a physical block that includes previously written data is not updated to append new data or logical block therein. Rather, the new data is written to the next physical block in the zone of the SMR storage device. This can result in wasted space in the physical blocks if the logical blocks being written are smaller than the physical blocks. For example, typical file systems create objects to be written that are 512 bytes in size. In contrast, currently the size of the physical blocks are 4096 bytes in SMR storage devices. Furthermore, the size of the physical blocks in SMR storage devices is projected to increase over time (e.g., 64 kilobytes, 128 kilobytes, etc.). Therefore, in some embodiments, the logical blocks are buffered in this same FIFO for a given zone. Once the size of the logical blocks stored in the FIFO equal the size of a physical block, the logical blocks can then be written to a physical block in a zone of the SMR drive. Thus, some embodiments include dual-use FIFOs. While embodiments herein are described as using a FIFO, some embodiments can use other types of applicable data structures (e.g., arrays, tables, etc.).

The description of the embodiments below is divided into four sections. The first section describes examples having a dual-use FIFO for each open zone in an SMR storage device to provide for both wandering write protection and for buffering logical blocks for subsequent writes to physical blocks on the SMR storage device. The second section describes examples having a single-use FIFO for each open zone in an SMR drive to provide for wandering write protection. The third section describes an example computer device, and the fourth section describes some possible variations and general comments for embodiments described herein.

Dual-Use FIFO that Provides Wandering Write Protection

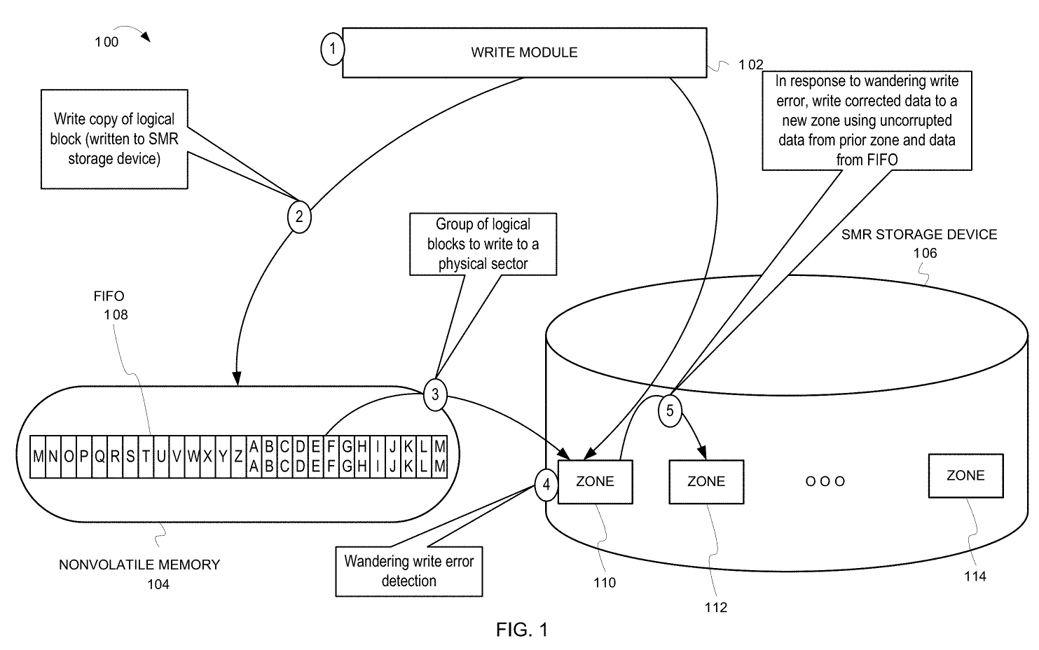

This section includes a description of FIGS. 1-4 to help illustrate using a dual-use FIFO for each open zone in an SMR drive to provide for wandering write protection.

FIG. 1 depicts a system using a dual-use FIFO to provide for wandering write protection and logical block buffering in an SMR storage device, according to some embodiments. A system 100 includes a write module 102 coupled with a nonvolatile memory 104, and an SMR storage device 106.

The write module 102 can be software, hardware, firmware, or a combination thereof. For example, the write module 102 can be part of an operating system for the system 100 to interface with a filesystem to provide for access to the nonvolatile memory 104 and the SMR storage device 106. The nonvolatile memory 104 can be different types of writeable nonvolatile storage devices. For example, the nonvolatile memory 104 can be flash memory, magnetic storage devices (e.g., hard disk drives). For sake of clarity, the nonvolatile memory 104 is shown storing a single FIFO (a FIFO 108). However, there can be multiple FIFOs, wherein each FIFO is associated with a different zone on the SMR storage device 106 that is open for writes.

In this example, the FIFO 108 is storing 27 logical blocks M, N, O, P, Q, R, S, T, U, V, W, X, Y, Z, AA, BB, CC, DD, EE, FF, GG, HH, II, JJ, KK, LL, and MM. The size of FIFO 108 can vary depending on the system 100, the type of data being written to the SMR storage device 106, etc. The size of the FIFO 108 can also vary depending on the specifications for the SMR storage device 106 that define the number of tracks that are susceptible to having data corrupted by a wandering write. For example, the size of the FIFO 108 can vary depending on the closeness of the tracks and the preciseness of the writes for the SMR storage device 106. To illustrate, the closer the tracks are to each other and the less precise the writes, the larger the size of the FIFO 108 can be. For example, SMR storage device A can be manufactured such that three previous tracks are susceptible to having data corrupted by a wandering write, while SMR storage device B can be manufactured such that five previous tracks are susceptible to having data corrupted by a wandering write. Also, the size of the tracks can vary among different SMR storage devices (e.g., one megabyte, one and one-half megabytes, etc.). Example sizes of the FIFO 108 can include six megabytes, four megabytes, eight megabytes, 10 megabytes, etc.

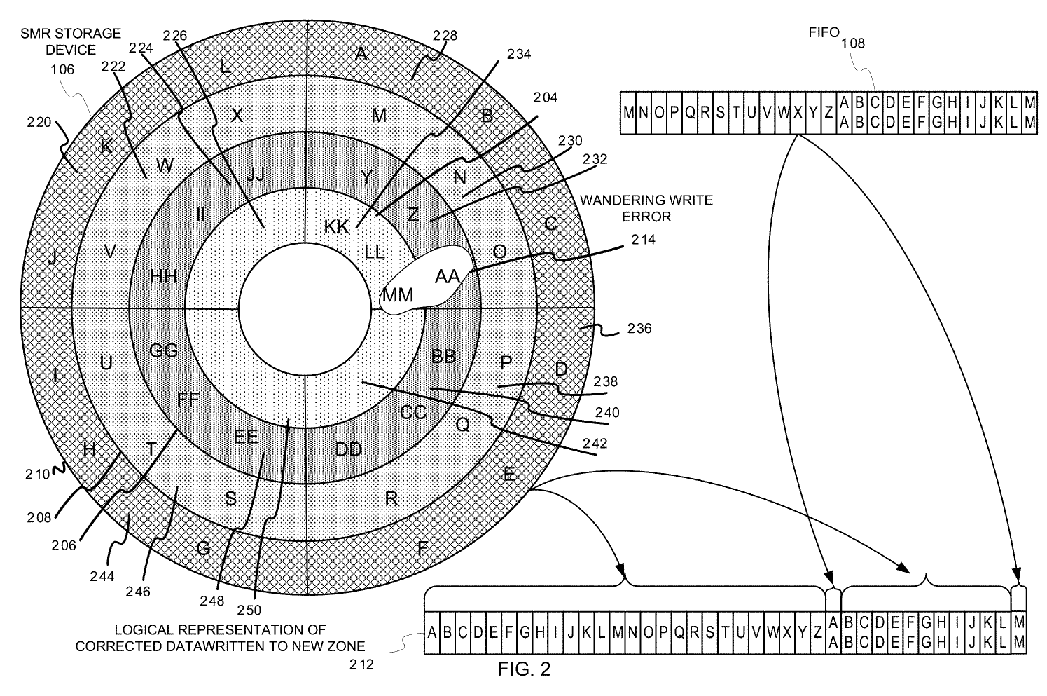

The SMR storage device 106 is partitioned into a number of zones (zones 110-114). Each zone can include a number of tracks. An example of part of an SMR storage device is depicted in FIG. 2, which is described in more detail below. Each zone can include a number of physical blocks or physical sectors for storage of data. Data can be written to sequential physical blocks within a zone (e.g., physical blocks that have monotonically increasing Physical Block Addresses (PBAs)). The zones 110-114 can be in different states (e.g., open, closed, etc.). If a zone is open, data can be written to the physical blocks therein. In some embodiments, each zone that is open has an associated FIFO. Thus, the number of FIFOs in the nonvolatile memory 104 can change over time as the number of zones that are open in the SMR storage device 106 changes.

FIG. 1 is annotated with a series of numbers 1-5. These numbers represent operational stages. Although these stages are ordered for this example, the stages illustrate one example to aid in understanding this disclosure and should not be used to limit the claims. Subject matter falling within the scope of the claims can vary with respect to the order and some of the operations. For example, stages 2-4 can be executed at least partially in parallel with each other.

At stage 1, the write module 102 receives an object to write. For example, the write module 102 can receive the object from a filesystem. The object can be received via any communication protocol associated with object based storage. For instance, the filesystem can receive the object from an application layer process that has received the object over a hypertext transfer protocol (HTTP) session, for example with a PUT command. The filesystem can then forward the object to the write module 102. The object can be any size, but the filesystem can ingest a large object (e.g., ranging from gigabytes to terabytes in size). The filesystem can also associate a time with the object (i.e., creates a time stamp for the object). The filesystem can use this time stamp to distinguish the arrival of this object instance (or version) from any other instance (or version) of the object. The write module 102 can divide the object into one or more logical blocks for storage in the SMR storage device 106. The write module 102 can also select an open zone in the SMR storage device 106 for storing the logical blocks. The write module 102 can use a write pointer that identifies where a write can continue from a previous write in the open zone. For instance, a write pointer identifies a physical sector within a track that follows a physical sector in which data was previously written. Thus, writes to a zone can progress forward through the zone until the write pointer is reset to the beginning of the zone.

At stage 2, the write module 102 writes a copy of the logical block written to the SMR storage device 106 to the FIFO 108. As described above, each open zone in the SMR storage device 106 can have its own FIFO in the nonvolatile memory 104. Accordingly, the write module 102 can write a copy of the logical block to the FIFO associated with the open zone in the SMR storage device 106 where the logical block is to be written. The write module 102 can write a copy of the logical block to the tail of the FIFO 108, thereby being the newest entry therein. As subsequent copies of logical blocks are written to the FIFO 108, this copy of the logical block is moved through the FIFO 108 until it reaches the head and is dropped from the queue. In this example depicted in FIG. 1, the copy of the logical block can be stored behind the entry MM, thereby causing the other entries to shift and causing the oldest entry M to be dropped from the queue.

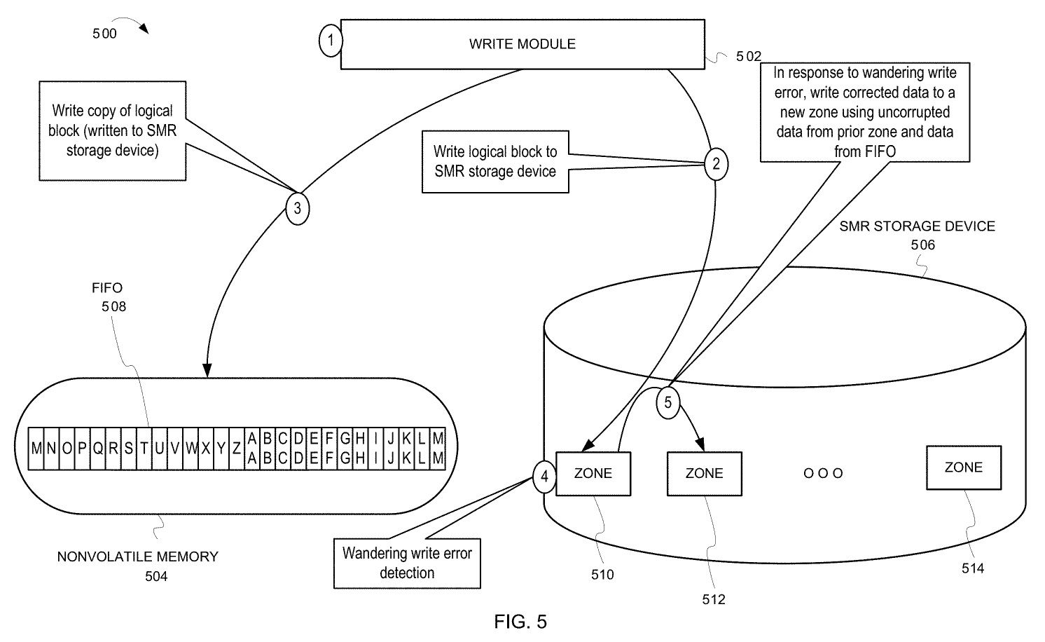

At stage 3, the write module 102 determines a size of the current logical block and the size of any of the previous copies in the FIFO 108 that have not yet been written to the SMR storage device 106. The write module 102 adds these two sizes together to determine whether this combined size equals a size of a physical block in the SMR storage device 106. For example, if the size of a logical block is 512 bytes and a size of a physical block or sector is 4096 bytes, eight logical blocks would fill the physical block. Therefore, if the current logical block and the number of previous copies in the FIFO 108 that have not yet been written to the SMR storage device 106 equals eight logical blocks, the combined sizes of the logical blocks to be written to the SMR storage device 106 equals the size of the physical block. If equal, the write module 102 writes the current logical block along with the previous copies of logical blocks in the FIFO 108 that have not yet been written to the SMR storage device 106 to an unwritten physical block available at the end of the zone 110. The write module 102 can write via a storage interface (not shown) with messages, commands, or function invocations acceptable by the storage interface for writing data to the SMR storage device 106. In some other embodiments, the write module 102 does not wait to write to a physical block until the physical block can be filled with logical blocks. One such example is depicted in FIGS. 5-7, which are described in more detail below.

At stage 4, a controller in the SMR storage device 106 can perform a wandering write error detection of the write of the logical block(s) to the SMR storage device 106 (at stage 3). For example, during the write of the logical block to a location on the track, movement of the write head relative to the location on the track can be monitored. If the write head relative to the location on the track is beyond a threshold distance, the controller in the SMR storage device 106 can determine that a wandering write error has occurred. If a wandering write error is detected, the controller in the SMR storage device 106 can assert an error signal. The error signal can interrupt a processor executing the write module 102. The write module 102 can then be notified of the wandering write error.

At stage 5, in response to a wandering write error being detected, any corrupted data caused by the wandering write error is replaced with uncorrupted data. SMR storage devices are configured such that update-in-place of data stored a zone is not allowed. Accordingly, the write module 102 can write the data from the zone 110 to a new open zone (the zone 112). As part of writing of the data to the new open zone, any corrupted data in the zone 110 is replaced with uncorrupted data that is stored in the FIFO 108. The write module 102 can check whether any data is corrupted in the SMR storage device 106 by comparing the data stored in the zone 110 to the corresponding copy stored in the FIFO 108. As described above, the FIFO 108 only stores a defined number of previously written logical blocks (depending on the size of the FIFO 108). For example, the size of the zone may be 256 megabytes, while the size of the FIFO may be only six megabytes. Therefore, the write module 102 may not be able to recover all corrupted data in the zone 110. In particular, the write module 102 can recover or correct uncorrupted data in the zone 110 if there is a corresponding copy of the data in the FIFO 108. If there is data in the zone 110 that has been corrupted but does not include a corresponding copy in the FIFO 108, other data recovery techniques such as erasure coding or parity can be used.

In some embodiments, as part of the recovery of data that is corrupted in the zone 110, the write module 102 can copy all of the data in the zone 110 to a volatile memory (not shown). The write module 102 can then perform a checksum or hash over data in a given physical sector of the zone 110. The write module 102 can then perform another checksum or hash over the corresponding data that is stored in the FIFO 108. For example, the checksum or hash can be performed on individual logical blocks or a group of logical blocks in a given physical sector of the zone 110. The write module 102 performs the checksum or hash over the logical block(s) from the physical sector of the zone 110 and over the corresponding copies of the logical block(s) in the FIFO 108. If the two checksums or hashes match, the data is uncorrupted. Conversely, if the two checksums or hashes do not match, the data is corrupted. Thus, the write module 102 can then write data to the new open zone 112 using a combination of the data from the zone 110 and at least some of the copies of data from the FIFO 108.

To help illustrate these operations, FIG. 2 depicts a more detailed diagram of a part of an SMR storage device and a nonvolatile memory used to correct corrupted data caused by a wandering write error, according to some embodiments. FIG. 2 depicts a portion having a current zone of the SMR storage device 106, the FIFO 108, and a logical representation 212 of a new zone written with uncorrupted data from the current zone and corrected data from FIFO 108. The portion of the SMR storage device 106 depicted in FIG. 2 includes a number of tracks—a track 204, a track 206, a track 208, and a track 210. Each track includes a number of physical blocks or sectors.

The track 204 includes a physical block 226, a physical block 234, a physical block 242, and a physical block 250. The track 206 includes a physical block 224, a physical block 232, a physical block 240, and a physical block 248. The track 208 includes a physical block 222, a physical block 230, a physical block 238, and a physical block 246. The track 210 includes a physical block 220, a physical block 228, a physical block 236, and a physical block 244. In this example, the physical block 226, the physical block 234, the physical block 242, the physical block 250, the physical block 224, the physical block 232, the physical block 240, the physical block 248, the physical block 222, the physical block 230, the physical block 238, the physical block 246, the physical block 220, the physical block 228, the physical block 236, and the physical block 244 can be at least part of the physical blocks defined to be part of an open zone where data can be written. With reference to FIG. 1, these physical blocks can be part of the zone 110 where data is being written.

Each physical block or sector can include multiple logical blocks. In some embodiments, a size of a logical block can be 512 bytes, and a size of a physical block or sector can be 4096 bytes (i.e., eight logical blocks can be stored in a physical block). However, the size of the logical blocks and physical blocks can vary. In this example, each physical block includes three logical blocks. The physical block 220 includes three logical blocks J, K, and L. The physical block 222 includes three logical blocks V, W, and X. The physical block 224 includes three logical blocks HH, II, and JJ. The physical block 226 is not currently storing any logical blocks. The physical block 228 includes three logical blocks A, B, and C. The physical block 230 includes three logical blocks M, N, and O. The physical block 232 includes three logical blocks Y, Z, and AA. The physical block 234 includes three logical blocks KK, LL, and MM. The physical block 236 includes three logical blocks D, E, and F. The physical block 238 includes three logical blocks P, Q, and R. A physical block 240 includes three logical blocks BB, CC, and DD. The physical block 242 is not currently storing any logical blocks. The physical block 244 includes three logical blocks G, H, and I. The physical block 246 includes three logical blocks S, T, and U. The physical block 248 includes three logical blocks EE, FF, and GG. The physical block 250 is not currently storing any logical blocks.

The FIFO 108 is storing 27 logical blocks M, N, O, P, Q, R, S, T, U, V, W, X, Y, Z, AA, BB, CC, DD, EE, FF, GG, HH, II, JJ, KK, LL, and MM. The logical representation 212 depicts how a new zone can be created that includes uncorrupted data from the current zone and corrected data from the FIFO 108. For example, FIG. 2 depicts the operations at stage 5 of FIG. 1 in which corrected data is written to a new zone (the zone 112) using uncorrupted data from the current zone (the zone 110) and data from the FIFO 108.

As described above, in response to a wandering write error being detected, the write module will copy the uncorrupted data from the current zone along with corrected data from the FIFO in substitution of any corrupted data to a new zone. In this example, the current zone includes the physical blocks of the SMR storage device 106 depicted in FIG. 2, the physical blocks 226, 234, 242, 250, 224, 232, 240, 248, 222, 230, 238, 246, 220, 228, 236, and 244. The write module 102 can determine the oldest entry (the head) in the FIFO 108. In this example, the oldest entry in the FIFO 108 is the logical block M.

Beginning at the front of the zone 110, the write module 102 can then write the logical blocks in the current zone (the zone 110) from the SMR storage device 106 that do not have a counterpart in the FIFO 108. In this example, the logical blocks in the zone 110 that do not have a counterpart in the FIFO 108 includes the logical blocks A-L. Thus, the write module 102 can write the following physical blocks to the new zone (the zone 112) in the following order:

a. the physical block 228 that includes the logical blocks A-C;

b. the physical block 236 that includes the logical blocks D-F;

c. the physical block 244 that includes the logical blocks G-I; and

d. the physical block 220 that includes the logical blocks J-L.

The write module 102 can then begin comparing the logical blocks in the current zone (the zone 110) to the logical blocks in the FIFO 108. The comparison can be between individual logical blocks or the group of logical blocks in a physical block. In this example, the comparison is performed on individual logical blocks.

The write module 102 can first determine whether the logical block M stored in the physical block 230 has been corrupted. The write module 102 performs a hash or checksum over the logical block M stored in the physical block 230. The write module 102 also performs a hash or checksum over the logical block M stored in the FIFO 108. If the two checksums or hashes match, the logical block M in the physical block 230 is uncorrupted. Conversely, if the two checksums or hashes do not match, the logical block M in the physical block 230 is corrupted. The write module 102 can perform this hash or checksum comparison on each of the other logical blocks N and O in the physical block 230. If any of the logical blocks M-O in the physical block 230 are corrupted, the write module 102 can write the copies of the logical blocks M-O from the FIFO 108 to the new zone (the zone 112) after the logical blocks from the physical block 220. The write module 102 can then write the logical blocks from the current zone that are uncorrupted to the new zone. In this example, the logical blocks M-O are uncorrupted. Therefore, the write module 102 can write the logical blocks M-O in the physical block 230 in the current zone to the new zone (after the logical blocks from the physical block 220).

The write module 102 can then process the logical blocks in the next physical block after the physical block 230 in the zone 110—the physical block 238. In particular, the write module 102 can perform the hash or checksum comparison for the logical blocks P-R in the physical block 238 based on the logical blocks P-R in the FIFO 108. If any of the logical blocks P-R in the physical block 238 are corrupted, the write module 102 can use the copies of the logical blocks P-R from the FIFO 108 to write corrected data to the new zone (the zone 112) after the logical blocks from the physical block 230. In this example, the logical blocks P-R are uncorrupted. Therefore, the write module 102 can write the logical blocks P-R in the physical block 238 in the current zone to the new zone (after the logical blocks from the physical block 230).

The write module 102 can then process the logical blocks in the next physical block after the physical block 238 in the zone 110—the physical block 246. In particular, the write module 102 can perform the hash or checksum comparison for the logical blocks S-U in the physical block 246 based on the logical blocks S-U in the FIFO 108. If any of the logical blocks S-U in the physical block 246 are corrupted, the write module 102 can use the copies of the logical blocks S-U from the FIFO 108 to write corrected data to the new zone (the zone 112) after the logical blocks from the physical block 238. In this example, the logical blocks S-U are uncorrupted. Therefore, the write module 102 can write the logical blocks S-U in the physical block 246 in the current zone to the new zone (after the logical blocks from the physical block 238).

The write module 102 can then process the logical blocks in the next physical block after the physical block 246 in the zone 110—the physical block 222. In particular, the write module 102 can perform the hash or checksum comparison for the logical blocks V-X in the physical block 222 based on the logical blocks V-X in the FIFO 108. If any of the logical blocks V-X in the physical block 222 are corrupted, the write module 102 can use the copies of the logical blocks V-X from the FIFO 108 to write corrected data to the new zone (the zone 112) after the logical blocks from the physical block 246. In this example, the logical blocks V-X are uncorrupted. Therefore, the write module 102 can write the logical blocks V-X in the physical block 222 in the current zone to the new zone (after the logical blocks from the physical block 246).

The write module 102 can then process the logical blocks in the next physical block after the physical block 222 in the zone 110—the physical block 232. In particular, the write module 102 can perform the hash or checksum comparison for the logical blocks Y, Z, and AA in the physical block 232 based on the logical blocks Y, Z, and AA in the FIFO 108. If any of the logical blocks Y, Z, and AA in the physical block 232 are corrupted, the write module 102 can use the copies of the logical blocks Y, Z, and AA from the FIFO 108 to write corrected data to the new zone (the zone 112) after the logical blocks from the physical block 222. In this example, the logical blocks Y and Z are uncorrupted. However, the logical block AA is corrupted—shown by the wandering write error 214. In particular, the wandering write error 214 occurred during a write operation of the logical block MM in a subsequent track—the track 234. Therefore, the write module 102 can write the copies of the logical blocks Y, Z, and AA from the FIFO 108 to the new zone (the zone 112) after the logical blocks from the physical block 222. Alternatively, the write module 102 can use the logical blocks Y-Z from the current zone in combination with a copy of the logical block AA from the FIFO 108 to perform a write to the physical block in the new zone.

The write module 102 can then process the logical blocks in the next physical block after the physical block 232 in the zone 110—the physical block 240. In particular, the write module 102 can perform the hash or checksum comparison for the logical blocks BB, CC, and DD in the physical block 240 based on the logical blocks BB, CC, and DD in the FIFO 108. If any of the logical blocks BB, CC, and DD in the physical block 240 are corrupted, the write module 102 can use the copies of the logical blocks BB, CC, and DD from the FIFO 108 to write corrected data to the new zone (the zone 112) after the logical blocks from the physical block 232. In this example, the logical blocks BB, CC, and DD are uncorrupted. Therefore, the write module 102 can write the logical blocks BB, CC, and DD in the physical block 240 in the current zone to the new zone (after the logical blocks from the physical block 232).

The write module 102 can then process the logical blocks in the next physical block after the physical block 240 in the zone 110—the physical block 248. In particular, the write module 102 can perform the hash or checksum comparison for the logical blocks EE, FF, and GG in the physical block 248 based on the logical blocks EE, FF, and GG in the FIFO 108. If any of the logical blocks EE, FF, and GG in the physical block 248 are corrupted, the write module 102 can use the copies of the logical blocks EE, FF, and GG from the FIFO 108 to write corrected data to the new zone (the zone 112) after the logical blocks from the physical block 240. In this example, the logical blocks EE, FF, and GG are uncorrupted. Therefore, the write module 102 can write the logical blocks EE, FF, and GG in the physical block 248 in the current zone to the new zone (after the logical blocks from the physical block 240).

The write module 102 can then process the logical blocks in the next physical block after the physical block 248 in the zone 110—the physical block 224. In particular, the write module 102 can perform the hash or checksum comparison for the logical blocks HH, II, and JJ in the physical block 224 based on the logical blocks HH, II, and JJ in the FIFO 108. If any of the logical blocks HH, II, and JJ in the physical block 224 are corrupted, the write module 102 can use the copies of the logical blocks HH, II, and JJ from the FIFO 108 to write corrected data to the new zone (the zone 112) after the logical blocks from the physical block 248. In this example, the logical blocks HH, II, and JJ are uncorrupted. Therefore, the write module 102 can write the logical blocks HH, II, and JJ in the physical block 224 in the current zone to the new zone (after the logical blocks from the physical block 224).

The write module 102 can then process the logical blocks in the next physical block after the physical block 224 in the zone 110—the physical block 234. In particular, the write module 102 can perform the hash or checksum comparison for the logical blocks KK, LL, and MM in the physical block 234 based on the logical blocks KK, LL, and MM in the FIFO 108. If any of the logical blocks KK, LL, and MM in the physical block 234 are corrupted, the write module 102 can use the copies of the logical blocks KK, LL, and MM from the FIFO 108 to write corrected data to the new zone (the zone 112) after the logical blocks from the physical block 224. In this example, the logical blocks KK, LL, and MM are uncorrupted. Therefore, the write module 102 can write the logical blocks KK, LL, and MM in the physical block 234 in the current zone to the new zone (after the logical blocks from the physical block 224). As described above, the writing of the logical block MM resulted in the wandering write error 214 that corrupted the logical block AA. The wandering write error 214 was corrected during the writing of the physical block 232 to the new zone.

Alternative to the operations described above, in some embodiments, once a wandering write error is detected, the current logical block with the corrupted data and any subsequent logical blocks in the FIFO 108 are used in creation of the new zone. With reference to FIG. 2, after detection of the corrupted data in the logical block AA, the write module 102 copies the logical blocks AA-MM in the FIFO 108 to the new zone.

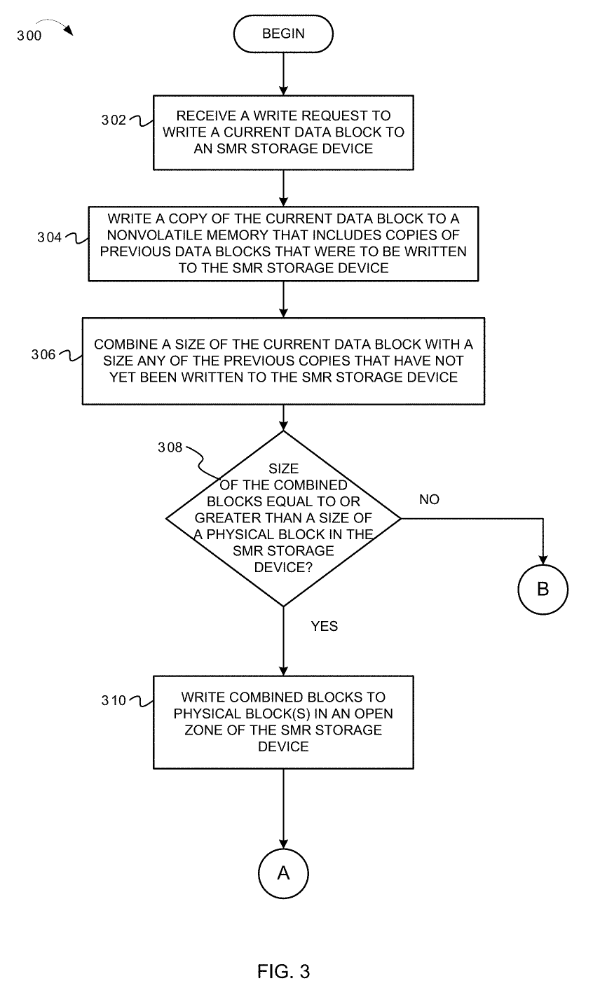

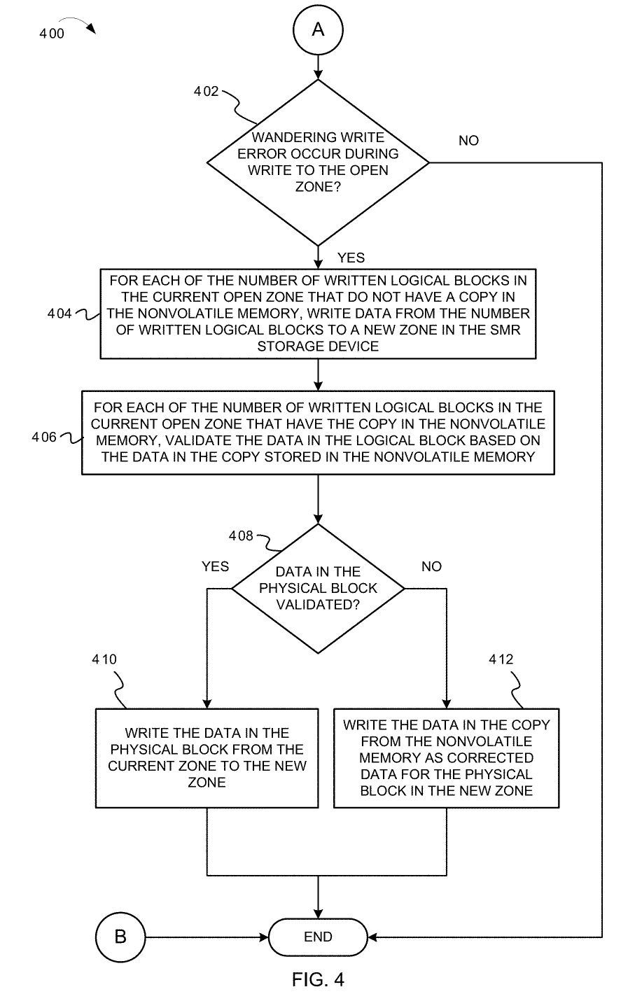

To further illustrate operations of the system 100 of FIG. 1, FIGS. 3-4 depict flowcharts to provide for wandering write protection and logical block buffering in an SMR storage device using a dual-use FIFO, according to some embodiments. A flowchart 300 of FIG. 3 and a flowchart 400 of FIG. 4 are described with reference to FIGS. 1-2. Operations of the flowchart 300 continue through transition points A and B to operations of the flowchart 400. Operations of the flowchart 300 and the flowchart 400 can be performed by software, firmware, hardware or a combination thereof (see for example the write module 102 in FIG. 1). The operations of the flowchart 300 start at block 302.

At block 302, a write request is received to write a current data block to an SMR storage device. With reference to FIG. 1, the write module 102 can receive an object to write to the SMR storage device 106. As described above, the write module 102 can receive the object from a filesystem. The write module 102 can divide the object into one or more logical blocks for storage in the SMR storage device 106. The write module 102 can also select an open zone in the SMR storage device 106 for storing the logical blocks. The write module 102 can use a write pointer that identifies where a write can continue from a previous write in the open zone. Operations of the flowchart 300 continue at block 304.

At block 304, a copy of the current data block is written to a nonvolatile memory that includes copies of previous data blocks that were written and are to be written to the SMR storage device. With reference to FIG. 1, the write module 102 writes a copy of the logical block (to be written to the SMR storage device 106) to the FIFO 108 in the nonvolatile memory 104. The write module 102 can write a copy of the logical block to the FIFO associated with the open zone in the SMR storage device 106 where the logical block is to be written. The write module 102 can write a copy of the logical block to the tail of the FIFO, thereby entering the new entry therein. As subsequent copies of logical blocks are written to the FIFO 108, this copy of the logical block is moved through the FIFO 108 until it reaches the head and is dropped from the queue. Operations of the flowchart 300 continue at block 306.

At block 306, a copy of the current data block is then combined with any of copies of previous data blocks that have not yet been written to the SMR storage device to create a combined block to determine its combined size. With reference to FIG. 1, the write module 102 can combine a size of the current logical block with the sizes of any of the previous copies in the FIFO 108 that have not yet been written to the SMR storage device 106. Operations of the flowchart 300 continue at block 308.

At block 308, a determination is made of whether the size of the combined blocks is equal to or greater than the size of a physical block in the SMR storage device. With reference to FIG. 1, the write module 102 can make this determination. If the size of the combined blocks is not equal to or greater than the size of a physical block in the SMR storage device, operations continue at transition point B, which continues at transition point B in the flowchart 400 of FIG. 4, which is completion of the operations. Otherwise, if the sizes are equal to or greater than the size of the physical block in the SMR storage device, operations of the flowchart 300 continue at block 310.

At block 310, the combined blocks are written to physical block(s) in the designated open zone of the SMR storage device. With reference to FIG. 1, the write module 102 can write the combined blocks to unwritten physical blocks at the end of the zone 110. Combined blocks of unwritten data can be written to one or more physical blocks in the open zone. In particular, if the FIFO 108 has buffered a quantity of data greater than or equal to the size of the physical block, the write module 102 writes as many physical blocks' worth of data that is stored in the FIFO 108 to the open zone. This can be one or more physical blocks that are written to the open zone. These write operations by the write module 102 can be performed “eagerly” (i.e., as soon as enough data has amassed in the FIFO 108), can be performed “lazily” (i.e., only after the FIFO 108 is filled up and must free space therein to accommodate subsequent write requests), or can be performed according to some intermediate criteria. Any data remaining in the FIFO 108 can be held to be combined with subsequently written data into the FIFO 108. Operations of the flowchart 300 continue at transition point A, which continues at transition point A in the flowchart 400 of FIG. 4 (which is now described).

The flowchart 400 of FIG. 4 starts at transition point A. From transition point A, operations continue at block 402.

At block 402, a determination is made of whether a wandering write error occurred during the write to the open zone. With reference to FIG. 1, a controller in the SMR storage device 106 can make this determination. For example, the controller can track the movement of the write head relative to the location on the track where the data is being written. If the write head relative to the location on the track is beyond a threshold distance, a wandering write error can be defined as occurring. If no wandering write error occurred, operations of the flowchart 400 are complete. If a wandering write error did occur, operations of the flowchart 400 continue at block 404.

At block 404, for each of the number of written logical blocks stored in the current open zone that do not have a corresponding copy in the nonvolatile memory (the FIFO), the data from these number of written logical blocks is written to a new zone in the SMR storage device. With reference to FIG. 1, the write module 102 can perform this operation. As described above, the FIFO 108 only stores a defined number of previously written logical blocks (depending on the size of the FIFO 108). Therefore, every logical block stored in the current open zone may not have a corresponding copy in the FIFO 108. Therefore, for those logical blocks in the current open zone that do not have a corresponding copy in the FIFO 108 within the nonvolatile memory 104, the write module 102 copies the logical blocks from the current open zone (the zone 110) to a new zone (the zone 112). In other words, no check of wandering write errors can be performed using the data stored in the FIFO 108. Therefore, the data in these logical blocks are moved to the new zone without checking for a wandering write error. Operations of the flowchart 400 continue at block 406.

At block 406, for each of the number of written logical blocks stored in the current open zone that do have a corresponding copy in the nonvolatile memory (the FIFO), the data from these number of written logical blocks is validated based on the corresponding copies stored in the nonvolatile memory. With reference to FIG. 1, the write module 102 can perform this operation (as described above). For example, the write module 102 can perform a checksum or hash over data in a given physical sector of the zone 110. The write module 102 can then perform another checksum or hash over the corresponding data that is stored in the FIFO 108. For example, the checksum or hash can be performed on individual logical blocks or a group of logical blocks in a given physical sector of the zone 110. If the two checksums or hashes match, the data is uncorrupted (thus validated). Conversely, if the two checksums or hashes do not match, the data is corrupted (thus invalidated). The write module 102 can perform this validation for each logical block or group of logical blocks in the zone 110. Operations of the flowchart continue at block 408.

At block 408, for each logical block or group of logical blocks, a determination of validation is made. With reference to FIG. 1, the write module 102 can make this determination based on the comparison of the checksums or hashes (described above). For each logical block or group of logical blocks in a physical block or sector, if the data is validated, operations of the flowchart 400 continue at block 410. If not validated, operations of the flowchart 400 continue at block 412.

At block 410, the data in the physical block from the current zone is written to the new zone. With reference to FIG. 1, the write module 102 can write the data from the physical block in the current zone (the zone 110) to a physical block in the new zone (the zone 112) in the SMR storage device 106.

Alternatively, at block 412, the data in the copy from the nonvolatile memory (the FIFO) is written as corrected data to the physical block in the new zone. With reference to FIG. 1, the write module 102 can write the data from the physical block in the current zone (the zone 110) to the new zone (the zone 112) in the SMR storage device 106. Thus, the write module 102 can walk sequentially through the current zone (starting from the beginning). The write module can then write data to the new open zone 112 using a combination of the data from the zone 110 and at least some of the copies of data from the FIFO 108 (depending on which data is corrupted). Operations of the flowchart 400 are complete.

### Single-Use FIFO-based Wandering Write Protection

This section includes a description of FIGS. 5-7 to help illustrate using a single-use FIFO for each open zone in an SMR storage device to provide for wandering write protection.

FIG. 5 depicts a system using a FIFO to provide for wandering write protection in an SMR storage device, according to some embodiments. A system 500 includes a write module 502 coupled with a nonvolatile memory 504, and an SMR storage device 506. The nonvolatile memory 504 is configured to store a FIFO 508. In some embodiments, the write module 502, the nonvolatile memory 504, the SMR storage device 506, and the FIFO 508 are similar to the write module 102, the nonvolatile memory 104, the SMR storage device 106, and the FIFO 108, respectively, of FIG. 1 (described above). Similar to the nonvolatile memory 104, the nonvolatile memory 504 is shown storing a single FIFO (a FIFO 508). However, there can be multiple FIFOs, wherein each FIFO is associated with a different zone on the SMR storage device 506 that is open for writes. Like the FIFO 108, the FIFO 508 is storing 27 logical blocks M, N, O, P, Q, R, S, T, U, V, W, X, Y, Z, AA, BB, CC, DD, EE, FF, GG, HH, II, JJ, KK, LL, and MM. However, in some embodiments (in contrast to the logical blocks in the dual-use FIFO configuration (described above)), the size of the logical blocks is equal to a size of a physical block in the SMR storage device 506. The sizing of these logical blocks for the system depicted in FIG. 5 is further described below.

The SMR storage device 506 is partitioned into a number of zones (zones 510-514). Each zone can include a number of tracks. An example of part of an SMR storage device is depicted in FIG. 2 (described above). Each zone can include a number of physical blocks or physical sectors for storage of data. Data can be written to sequential physical blocks within a zone (e.g., physical blocks that have monotonically increasing Physical Block Addresses (PBAs)). The zones 510-514 can be in different states (e.g., open, closed, etc.). In some embodiments, each zone that is open has an associated FIFO. Thus, the number of FIFOs in the nonvolatile memory 504 can change over time as the number of zones that are open in the SMR storage device 506 changes.

FIG. 5 is annotated with a series of numbers 1-5. These numbers represent operational stages. Although these stages are ordered for this example, the stages illustrate one example to aid in understanding this disclosure and should not be used to limit the claims. Subject matter falling within the scope of the claims can vary with respect to the order and some of the operations. For example, stages 2-4 can be executed at least partially in parallel with each other.

At stage 1, the write module 502 receives an object to write. For example, the write module 502 can receive the object from a filesystem. The object can be received via any communication protocol associated with object based storage. For instance, the filesystem can receive the object from an application layer process that has received the object over a hypertext transfer protocol (HTTP) session, for example with a PUT command. The filesystem can then forward the object to the write module 102. The object can be any size, but the filesystem can ingest a large object (e.g., ranging from gigabytes to terabytes in size). The filesystem can also associate a time with the object (i.e., creates a time stamp for the object). The filesystem can use this time stamp to distinguish the arrival of this object instance (or version) from any other instance (or version) of the object. In some embodiments, the unit of a write to the SMR storage device 506 is the physical block which can contain an integral multiple of the number of bytes in a logical block (e.g., 4096 bytes in a physical block v. 512 bytes in a logical block). Therefore, the write module 502 can divide the object into logical blocks having a size equal to physical block of the SMR storage device 506. Also, any leftover bytes from the divided object can be stored in a logical block that is then padded (e.g., 0 bytes) to become an integral multiple of the physical block size before being written to the SMR storage device 506. The write module 502 can select an open zone in the SMR storage device 506 for storing the logical blocks. The write module 502 can use a write pointer that identifies where a write can continue from a previous write in the open zone. For instance, a write pointer identifies a physical sector within a track that follows a physical sector in which data was previously written. Thus, writes to a zone can progress forward through the zone until the write pointer is reset to the beginning of the zone.

At stage 2, the write module 502 writes a logical block to an open zone in the SMR storage device 506. The write module 502 can write via a storage interface (not shown) with messages, commands, or function invocations acceptable by the storage interface for writing data to the SMR storage device 506. In this example, the write module 502 writes the logical block to a physical block at the end of the zone 510. For example, the write module 502 can write the logical block at the beginning of a physical block boundary at the end of the zone 510.

At stage 3, the write module 502 writes a copy of the logical block (written to the SMR storage device 506) to the FIFO 508. As described above, each open zone in the SMR storage device 506 can have its own FIFO in the nonvolatile memory 508. Accordingly, the write module 502 can write a copy of the logical block to the FIFO associated with the open zone in the SMR storage device 506 where the logical block is written. The write module 502 can write a copy of the logical block to the tail of the FIFO 508, thereby being the new entry therein. As subsequent copies of logical blocks are written to the FIFO 508, this copy of the logical block is moved through the FIFO 508 until it reaches the head and is dropped from the queue. In this example, the copy of the logical block can be stored behind the entry MM, thereby causing the other entries to shift and causing the oldest entry M to be dropped from the queue.

At stage 4, a controller in the SMR storage device 506 performs a wandering write error detection of the write of the logical block (at stage 2). For example (as described above), during the write of the logical block to a location on the track, movement of the write head relative to the location on the track can be monitored. If the write head relative to the location on the track is beyond a threshold distance, a wandering write error can be defined as occurring.

At stage 5, in response to a wandering write error being detected, any corrupted data caused by the wandering write error is replaced with uncorrupted data. SMR storage devices are configured such that update-in-place of data stored a zone is not allowed. Accordingly, the write module 502 can write the data from the zone 510 to a new open zone (the zone 512). As part of writing of the data to the new open zone, any corrupted data in the zone 510 is replaced with uncorrupted data that is stored in the FIFO 508. The write module 502 can check whether any data is corrupted by comparing the data stored in the zone 510 to the corresponding copy stored in the FIFO 508. As described above, the FIFO 508 only stores a defined number of previously written logical blocks (depending on the size of the FIFO 508). For example, the size of the zone may be 256 megabytes, while the size of the FIFO may be only six megabytes. Therefore, the write module 502 may not be able to recover all corrupted data in the zone 510. In particular, the write module 502 can recover or correct uncorrupted data in the zone 510 if there is a corresponding copy of the data in the FIFO 508. If there is data in the zone 510 that has been corrupted but does not include a corresponding copy in the FIFO 508, other data recovery techniques such as erasure coding or parity can be used.

In some embodiments, as part of the recovery of data that is corrupted in the zone 510, the write module 502 can copy all of the data in the zone 510 to a volatile memory (not shown). The write module 502 can then perform a checksum or hash over data in a given physical sector of the zone 510. The write module 502 can then perform another checksum or hash over the corresponding data that is stored in the FIFO 508. For example, the checksum or hash can be performed on a logical block in a given physical sector of the zone 510. The write module 502 performs the checksum or hash over the logical block from the physical sector of the zone 510 and over the corresponding copy of the logical block in the FIFO 508. If the two checksums or hashes match, the data is uncorrupted. Conversely, if the two checksums or hashes do not match, the data is corrupted. The write module 502 can then write data to the new open zone 512 using a combination of the data from the zone 510 and at least some of the copies of data from the FIFO 508.

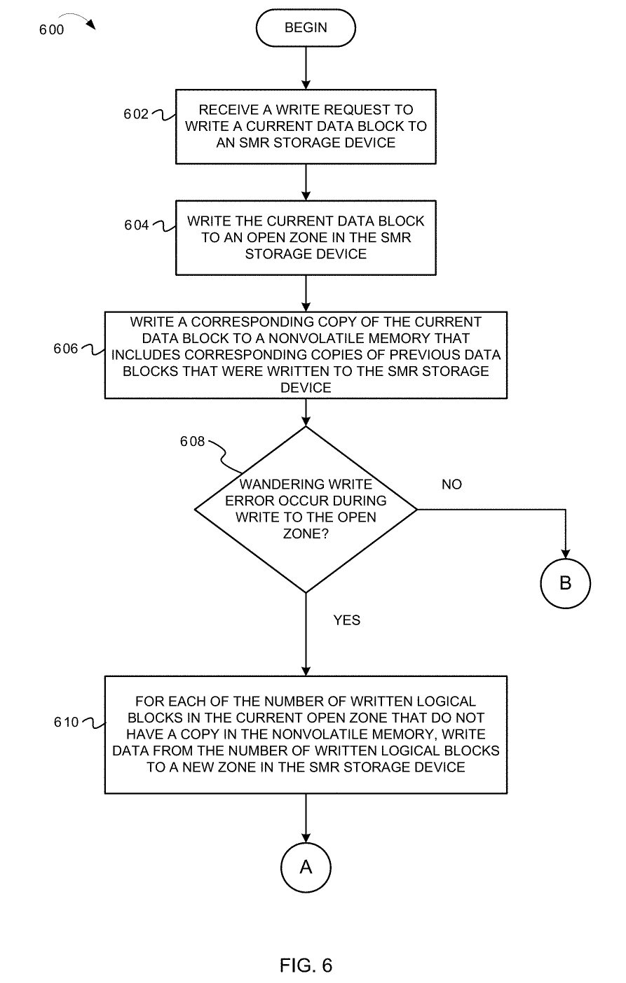

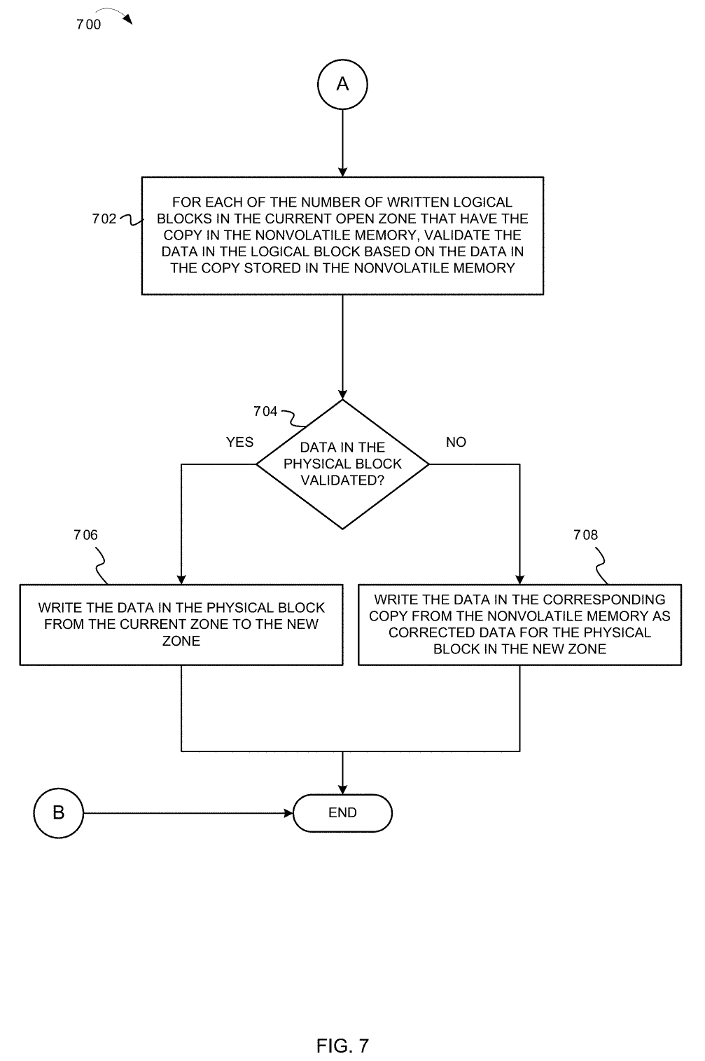

To further illustrate, FIGS. 6-7 depict flowcharts to provide for wandering write protection in an SMR storage device, according to some embodiments. A flowchart 600 of FIG. 6 and a flowchart 700 of FIG. 7 are described with reference to FIG. 5. Operations of the flowchart 600 continue through transition points A and B to operations of the flowchart 700. Operations of the flowchart 600 and the flowchart 700 can be performed by software, firmware, hardware or a combination thereof (see for example the write module 502 in FIG. 5). The operations of the flowchart 600 start at block 602.

At block 602, a write request is received to write a current data block to an SMR storage device. With reference to FIG. 5, the write module 502 can receive an object to write to the SMR storage device 506. As described above, the write module 502 can receive the object from a filesystem. The write module 502 can divide the object into one or more logical blocks (equaling the size of physical blocks in the SMR storage device 506) for storage in the SMR storage device 506. The write module 502 can select an open zone in the SMR storage device 506 for storing the logical blocks. The write module 502 can use a write pointer that identifies where a write can continue from a previous write in the open zone. Operations of the flowchart 600 continue at block 604.

At block 604, the current data block is written to an open zone in the SMR storage device. With reference to FIG. 5, the write module 502 can write the current data block to a physical block at the end of the zone 510 in the SMR storage device 506. Operations of the flowchart 600 continue at block 606.

At block 606, a copy of the current data block is written to a nonvolatile memory that includes copies of previous data blocks that were written to the SMR storage device. With reference to FIG. 5, the write module 502 writes a copy of the logical block (that was written to the SMR storage device 506) to the FIFO 508 in the nonvolatile memory 504. The write module 502 can write a copy of the logical block to the FIFO associated with the open zone in the SMR storage device 506 where the logical block is written. The write module 502 can write a copy of the logical block to the tail of the FIFO, thereby being the new entry therein. As subsequent copies of logical blocks are written to the FIFO 508, this copy of the logical block is moved through the FIFO 508 until it reaches the head and is dropped from the queue. Operations of the flowchart 600 continue at block 608.

At block 608, a determination is made of whether a wandering write error occurred during the write to the open zone. With reference to FIG. 5, a controller in the SMR storage device 506 can make this determination. For example, the controller can track the movement of the write head relative to the location on the track where the data is being written. If the write head relative to the location on the track is beyond a threshold distance, a wandering write error can be defined as occurring. If no wandering write error occurred, operations of the flowchart 600 continue at transition point B, which continues at transition point B of the flowchart 700, which is the completion of the operations. If a wandering write error did occur, operations of the flowchart 600 continue at block 610.

At block 610, for each of the number of written logical blocks stored in the current open zone that do not have a corresponding copy in the nonvolatile memory, the data from these number of written logical blocks is written to a new zone in the SMR storage device. With reference to FIG. 5, the write module 502 can perform this operation. As described above, the FIFO 508 only stores a defined number of previously written logical blocks (depending on the size of the FIFO 508). Therefore, every logical block stored in the current open zone may not have a corresponding copy in the FIFO 508. Therefore, for those logical blocks in the current open zone that do not have a corresponding copy in the FIFO 508 in the nonvolatile memory 504, the write module 502 copies the logical blocks from the current open zone (the zone 510) to a new zone (the zone 512). In other words, no check of wandering write errors can be performed using the data stored in the FIFO 508. Therefore, the data in these logical blocks are moved to the new zone without checking for a wandering write error. Operations of the flowchart 600 continue at transition point A, which continues at transition point A in the flowchart 700 of FIG. 7 (which is now described).

The flowchart 700 of FIG. 7 starts at transition point A. From transition point A, operations continue at block 702.

At block 702, for each of the number of written logical blocks stored in the current open zone that do have a corresponding copy in the nonvolatile memory, the data from these number of written logical blocks is validated based on the corresponding copies stored in the nonvolatile memory. With reference to FIG. 5, the write module 502 can perform this operation. For example, the write module 502 can perform a checksum or hash over data in a given physical sector of the zone 510. The write module 502 can then perform another checksum or hash over the corresponding data that is stored in the FIFO 508. For example, the checksum or hash can be performed on individual logical blocks or a group of logical blocks in a given physical sector of the zone 510. If the two checksums or hashes match, the data is uncorrupted (thus validated). Conversely, if the two checksums or hashes do not match, the data is corrupted (thus invalidated). The write module 502 can perform this validation for each logical block or group of logical blocks in the zone 510. Operations of the flowchart continue at block 704.

At block 704, for each logical block or group of logical blocks, a determination of validation is made. With reference to FIG. 5, the write module 502 can make this determination based on the comparison of the checksums or hashes (described above). For each logical block or group of logical blocks in a physical block or sector, if the data is validated, operations of the flowchart 700 continue at block 706. If not validated, operations of the flowchart 700 continue at block 708.

At block 706, the data in the physical block from the current zone is written to the new zone. With reference to FIG. 5, the write module 502 can write the data from the physical block in the current zone (the zone 510) to the new zone (the zone 512) in the SMR storage device 506.

Alternatively, at block 708, the data in the copy from the nonvolatile memory is written as corrected data to the physical block in the new zone. With reference to FIG. 5, the write module 502 can write the data from the physical block in the current zone (the zone 510) to the new zone (the zone 512) in the SMR storage device 506.

Thus, the write module 502 can walk sequentially through the current zone (starting from the beginning). The write module 502 can then write data to the new open zone 514 using a combination of the data from the zone 510 and at least some of the copies of data from the FIFO 508. Operations of the flowchart 700 are complete.

### Example Computer Device

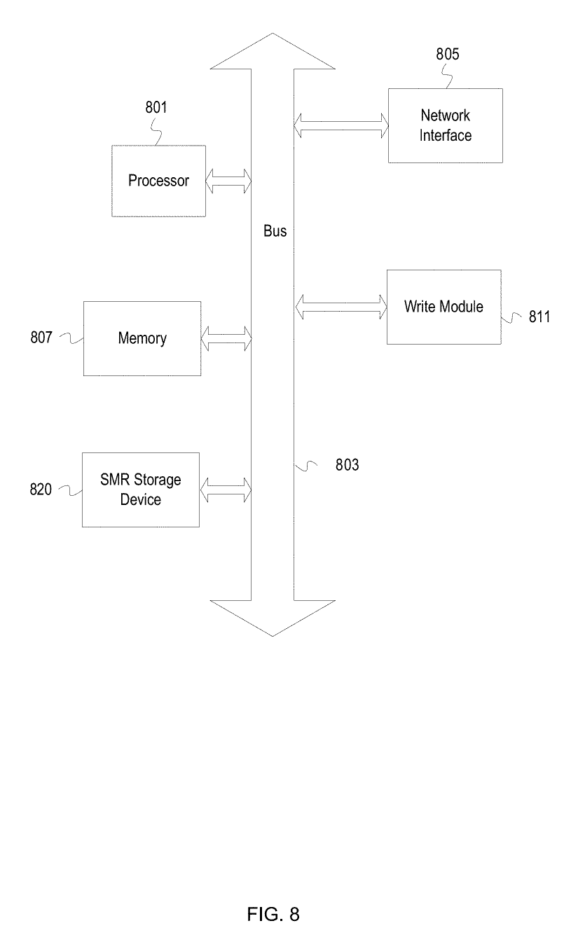

FIG. 8 depicts an example computer device, according to some embodiments. The computer device includes a processor 801 (possibly including multiple processors, multiple cores, multiple nodes, and/or implementing multi-threading, etc.). The computer device includes memory 807. The memory 807 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. For example, the memory 807 can represent the nonvolatile memory 108 and the nonvolatile memory 508 depicted in FIGS. 1 and 5, respectively.

The computer device also includes an SMR storage device 820. The SMR storage device 820 can represent the SMR storage device 106 and the SMR storage devices 506 depicted in FIGS. 1 and 5, respectively. Thus, the SMR storage device 820 can be an SMR-based magnetic storage device. The SMR storage device 820 can also include other types of storage devices. For example, the SMR storage device 820 can be a nonvolatile FLASH device. Alternatively or in addition, the SMR storage device 820 may not be limited to SMR-based writes.

The computer device also includes a bus 803 (e.g., PCI, ISA, PCI-Express, HyperTransport® bus, InfiniBand® bus, NuBus, etc.) and a network interface 805 (e.g., a Fiber Channel interface, an Ethernet interface, an internet small computer system interface, SONET interface, wireless interface, etc.). The computer device also includes a write module 811. The write module 811 can perform write and wandering write error protection for SMR storage devices as described above. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted for movement of data blocks between nodes of the data structure can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium. A machine readable storage medium does not include transitory, propagating signals.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

While the aspects of the disclosure are described with reference to various implementations and exploitations, it will be understood that these aspects are illustrative and that the scope of the claims is not limited to them. In general, techniques for sequenced-ordered translation for data storage as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

What is claimed is:

1. A method comprising:
receiving a write request to write a current data block to a Shingled Magnetic Recording (SMR) storage device; and
in response to receiving the write request,
writing the current data block to a current physical block in an open zone of the SMR storage device, wherein the open zone includes a number of written physical blocks that include stored data;
writing a corresponding copy of the current data block to a nonvolatile memory that includes corresponding copies of previous data blocks that were written to the SMR storage device;
determining whether a wandering write error occurred during the writing of the current data block to the open zone; and
in response to the wandering write error occurring, and for each of the number of written physical blocks in the open zone that have the corresponding copy in the nonvolatile memory,
validating data in the written physical block based on the corresponding copy; and
in response to the data in the written physical block not being validated, writing the data in the corresponding copy as corrected data for the written physical block to a new zone in the SMR storage device.

2. The method of claim 1, wherein the wandering write error is independent of a wandering write error that wrote to physical blocks in the open zone not including the current physical block that do not include stored data.

3. The method of claim 1, wherein in response to the wandering write error occurring, for each of the number of written physical blocks in the open zone that do not have a corresponding copy in the nonvolatile memory,
writing data from the number of written physical blocks in the open zone to a new zone in the SMR storage device.

4. The method of claim 1, wherein in response to the data in the written physical block being validated, writing the data in the written physical block to the new zone.

5. The method of claim 1, wherein validating the data in the written physical block comprises:
generating a first checksum across the data in the written physical block;
generating a second checksum across data of the corresponding copy in the nonvolatile memory; and
determining whether the first checksum equals the second checksum.

6. The method of claim 1, wherein the corresponding copy of the current data block and the corresponding copies of the previous data blocks are written into a First In First Out (FIFO) data structure.

7. The method of claim 1, wherein the wandering write error is generated in response to a vibration of the SMR storage device.

8. The method of claim 1, wherein the wandering write error comprises a wandering write error that overwrote data from at least one of the number of written physical blocks that include stored data.

9. One or more machine-readable storage media having program code for storing data blocks in a Shingled Magnetic Recording (SMR) storage device stored therein, the program code comprising instructions to:
receive a write request to write a current data block to a Shingled Magnetic Recording (SMR) storage device; and
in response to receipt of the write request,
write the current data block to a current physical block in an open zone of the SMR storage device, wherein the open zone includes a number of written physical blocks that include stored data;
write a corresponding copy of the current data block to a nonvolatile memory that includes corresponding copies of previous data blocks that were written to the SMR storage device;
determine whether a wandering write error occurred during the writing of the current data block to the open zone; and
in response to the wandering write error having occurred, and for each of the number of written physical blocks in the open zone that have the corresponding copy in the nonvolatile memory,
validate data in the written physical block based on the data in the corresponding copy; and
in response to the data in the written physical block not being validated, write the data in the corresponding copy as corrected data for the written physical block to a new zone in the SMR storage device.

10. The one or more machine-readable storage media of claim 9, wherein the wandering write error is independent of a wandering write error that wrote to written physical blocks in the open zone not including the current physical block that do not include stored data.

11. The one or more machine-readable storage media of claim 9, wherein the program code comprises instructions to:
in response to the wandering write error occurring, for each of the number of written physical blocks in the open zone that do not have the corresponding copy in the nonvolatile memory,
write data from the number of written physical blocks to a new zone in the SMR storage device.

12. The one or more machine-readable storage media of claim 9, wherein the program code comprises instructions to:
in response to the data in the written physical block being validated, write the data in the written physical block to the new zone.

13. The one or more machine-readable storage media of claim 9, wherein the program code comprising instructions to validate the data in the written physical block comprises program code having instructions to:
generate a first checksum across the data in the written physical block;
generate a second checksum across data of the corresponding copy; and
determine whether the first checksum equals the second checksum.

14. The one or more machine-readable storage media of claim 9, wherein the program code comprising instructions to write the corresponding copy of the current data block to the nonvolatile memory comprises program code having instructions to write the corresponding copy of the current data block to a First In First Out (FIFO) data structure that includes corresponding copies of previous data blocks that were written to the SMR storage device.

15. The one or more machine-readable storage media of claim 9, wherein the wandering write error is generated in response to a vibration of the SMR storage device.

16. The one or more machine-readable storage media of claim 9, wherein the wandering write error comprises a wandering write error that overwrote data from at least one of the number of written physical blocks that include stored data.

17. An apparatus comprising:
a processor;
a Shingled Magnetic Recording (SMR) storage device; and
a machine-readable medium having program code executable by the processor to cause the apparatus to,
receive a write request to write a current data block to the SMR storage device; and
in response to receipt of the write request,
write a current copy of the current data block to a nonvolatile memory that includes previous copies of previous data blocks that were written to the SMR storage device;
combine the current data block with any of the previous copies that have not yet been written to the SMR storage device to create combined blocks;
determine whether a size of the combined blocks is equal to or greater than a size of a physical block in the SMR storage device;
in response to the size of the combined blocks being equal to or greater than the size of the physical block, write at least part of the combined blocks equal to the size of the physical block to at least one physical block in an open zone of the SMR storage device,
wherein the open zone includes a number of written physical blocks that include stored data;
determine whether a wandering write error occurred during the writing of the combined blocks to the physical block; and
in response to the wandering write error having occurred,
for each of the number of written physical blocks in the open zone that do not have a copy of in the nonvolatile memory, write data from the number of written physical blocks to a new zone in the SMR storage device; and
for each of the number of written physical blocks in the open zone that have the copy in the nonvolatile memory,
validate the data in the physical block based on the data in the copy;
in response to the data in the physical block being validated, write the data in the physical block to the new zone; and
in response to the data in the physical block not being validated, write the data in the copy as corrected data for the physical block in the new zone.

18. The apparatus of claim 17, wherein the wandering write error is independent of a wandering write error that wrote to physical blocks in the open zone not including the current data block that do not include stored data.

19. The apparatus of claim 17, wherein the program code executable by the processor to cause the apparatus to validate the data in the physical block comprises program code executable by the processor to cause the apparatus to:
generate a first checksum across the data in the physical block;
generate a second checksum across data of the copy; and
determine whether the first checksum equals the second checksum.

20. The apparatus of claim 17, wherein the current copy of the current data block and the previous copies of the previous data blocks are written into a First In First Out (FIFO) data structure.
